(19) United States
(12) Patent Application Publication
(10) Pub. No.: US 2007/0159333 A1
(43) Pub. Date: Jul. 12, 2007

(54) Reader

(75) Inventor: Futoshi Deguchi, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO. ,LTD., Osaka (JP)

(21) Appl. No.: 11/637,899

(22) Filed: Dec. 13, 2006

(30) Foreign Application Priority Data
Dec. 14, 2005 (JP) 2005-359954

(51) Int. Cl. G08B 13/14

(52) U.S. Cl. 340/572.7

(57) ABSTRACT

It is an object of the invention to provide a reader of an RFID tag which can well carry out a communication with a plurality of RFID tags disposed to overlap each other. The reader according to the invention includes an antenna device for supplying a power and transmit data through an electromagnetic induction to a plurality of tags having an IC chip for storing predetermined information and a loop antenna and acquiring the information from the tags depending on a fluctuation in a load, wherein the antenna device has a conductor board, an antenna body provided spirally in a longitudinal direction of the conductor board over an outer peripheral surface of the conductor board, a power feeding portion coupled to the antenna body and serving to feed a power, and a ground connecting portion coupled to the antenna body and connected to a ground.

### BACKGROUND OF THE INVENTION

1. Field of the Invention

The present invention relates to an RFID communication technique for mainly utilizing a frequency in an HF band (13.56 MHz band) to carry out a communication with a plurality of RFID tags.

2. Description of the Related Art

As an antenna for an RFID reader/writer utilizing a frequency in an HF band (13.56 MHz band), conventionally, a circular or rectangular loop antenna device having one wind or a plurality of winds which is provided on the same plane has generally been used practically.

In the conventional loop antenna device for the RFID reader/writer, a magnetic field strength in a perpendicular direction to an opening surface thereof (a plane on an inside of an antenna defined by the antenna) (a direction of a central axis of the plane) is the greatest. Accordingly, a positional relationship between a loop antenna device provided in an RFID tag and a loop antenna device for the RFID reader/writer is generally set in such a manner that mutual opening surfaces are parallel with each other.

In the case in which the reader/writer carries out a communication with a plurality of RFID tags, moreover, a plurality of RFID tags are arranged on the same plane in such a manner that respective opening surfaces of the antennas do not overlap each other, and are disposed in such a manner that the respective opening surfaces of the antennas are parallel with the loop antenna for the RFID reader/writer.

FIG. 20 is an explanatory view showing a conventional antenna for an RFID reader/writer.

As shown in FIGS. 20(a) and 20(b), in a general circular or rectangular loop antenna 101 having one wind or a plurality of winds which is constituted on the same plane, a magnetic field strength is the greatest on a central axis Z of an opening surface S. FIG. 21 shows a change in the magnetic field strength at a point p on the central axis Z with an increase in a distance d in the case in which a distance between the point p and the loop antenna 101 is represented as “d”.

FIG. 21 is a graph showing a change in a distance and a magnetic field strength in an operating state of the conventional antenna for the RFID reader/writer. Consequently, it is apparent that the antenna cannot carry out a communication when the magnetic field strength is attenuated to be lower than an operating magnetic field Ht of a tag with an increase in the distance d. As shown in FIG. 20(b), furthermore, a magnetic flux density of a magnetic flux 102 is reduced with the increase in the distance d in this case. Accordingly, there is a drawback that a communication cannot be carried out between the reader/writer and the tag and a tag reading range obtained by the reader/writer is reduced when the tag is more distant than a distance d1 shown in FIG. 21.

### SUMMARY OF THE INVENTION

It is an object of the invention to provide a reader of an RFID tag which can carry out a communication with a plurality of RFID tags well.

A reader according to the invention comprises an antenna device for supplying a power and transmit data through an electromagnetic induction to a plurality of tags having an IC chip for storing predetermined information and a loop antenna and acquiring the information from the tags depending on a fluctuation in a load, wherein the antenna device has a conductor board, an antenna body provided spirally in a longitudinal direction of the conductor board over an outer peripheral surface of the conductor board, a power feeding portion coupled to the antenna body and serving to feed a power, and a ground connecting portion coupled to the antenna body and connected to a ground.

### BRIEF DESCRIPTION OF THE DRAWINGS

FIG. 1 is a schematic perspective view showing an RFID system according to a first embodiment of the invention,

FIG. 2 is a schematic perspective view showing an antenna device of a reader according to the first embodiment of the invention,

FIG. 3 is a perspective view showing a plurality of RFID tag antennas stuck to the reader and a product according to the first embodiment of the invention,

FIG. 4 is a perspective view showing the antenna device of the reader from which a casing is removed according to the first embodiment of the invention,

FIG. 5 is a bottom view showing the antenna device of the reader from which the casing is removed according to the first embodiment of the invention,

FIG. 6 is a sectional view showing the antenna device of the reader according to the first embodiment of the invention,

FIG. 7 is an explanatory view showing a resonant matching circuit portion of an RFID reader/writer according to the first embodiment of the invention,

FIG. 8 is an explanatory view showing a magnetic field distribution of an operating state of the antenna device of the reader according to the first embodiment of the invention,

FIG. 9 is a perspective view showing an antenna device for an RFID reader/writer from which a casing is removed according to a second embodiment of the invention,

FIG. 10 is a bottom view showing the antenna device of the reader from which the casing is removed according to the second embodiment of the invention,

FIG. 11 is a perspective view showing the antenna device for the RFID reader/writer from which the casing is removed according to the second embodiment of the invention,

FIG. 12 is an explanatory view showing a resonant matching load circuit portion of the antenna device for the RFID reader/writer according to the second embodiment of the invention,

FIG. 13 is a side view showing the antenna device for the RFID reader/writer from which the casing is removed according to the second embodiment of the invention,

FIG. 14 is a sectional view showing the antenna device for the RFID reader/writer from which the casing is removed according to the second embodiment of the invention,

FIG. 15 is a sectional view showing another antenna device for the RFID reader/writer from which a casing is removed according to the second embodiment of the invention,

FIG. 16 is a top view showing the antenna device for the RFID reader/writer from which the casing is removed according to the second embodiment of the invention,

FIG. 17 is a bottom view showing the antenna device for the RFID reader/writer from which the casing is removed according to the second embodiment of the invention,

FIG. 18 is a magnetic flux distribution diagram in an operating state of the antenna device for the RFID reader/writer according to the second embodiment of the invention,

FIG. 19 is a graph showing a change in a distance and a magnetic field strength in the operating state of the antenna device for the RFID reader/writer according to the second embodiment of the invention,

FIG. 20 is an explanatory view showing a conventional antenna device for an RFID reader/writer, and

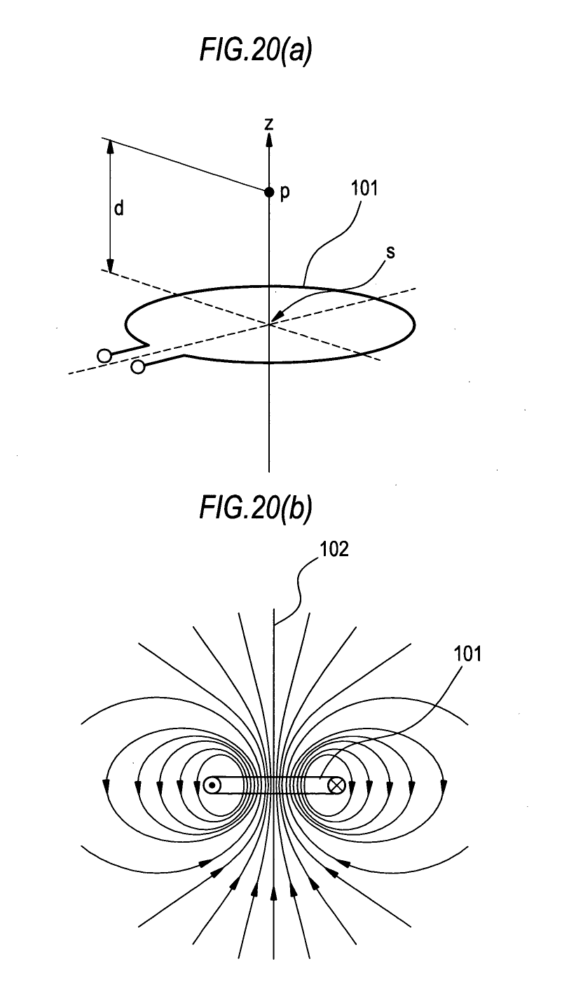

FIG. 21 is a graph showing a change in a distance and a magnetic field strength in an operating state of the conventional antenna device for the RFID reader/writer.

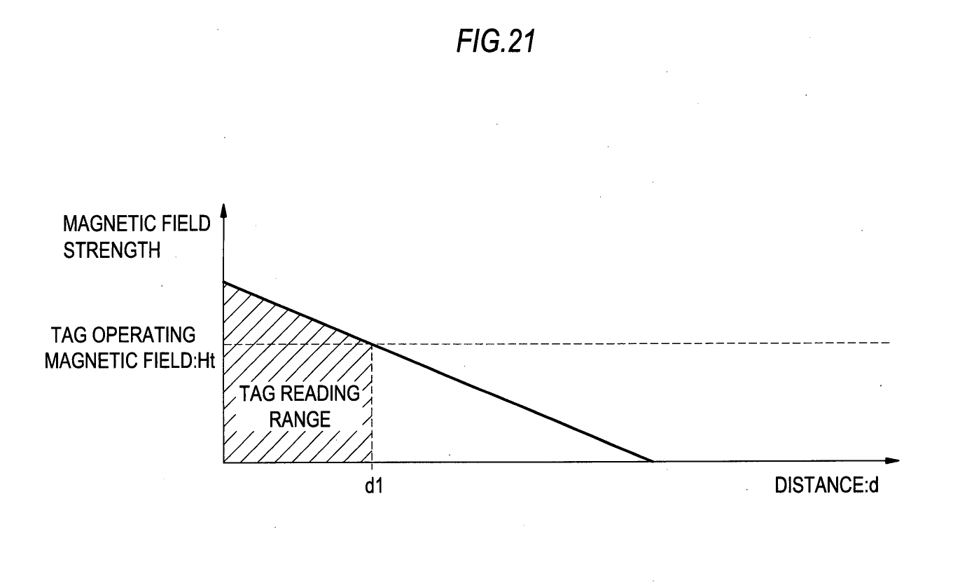

### DESCRIPTION OF THE PREFERRED EMBODIMENTS

First and second embodiments according to the invention will be described below with reference to the drawings.

### First Embodiment

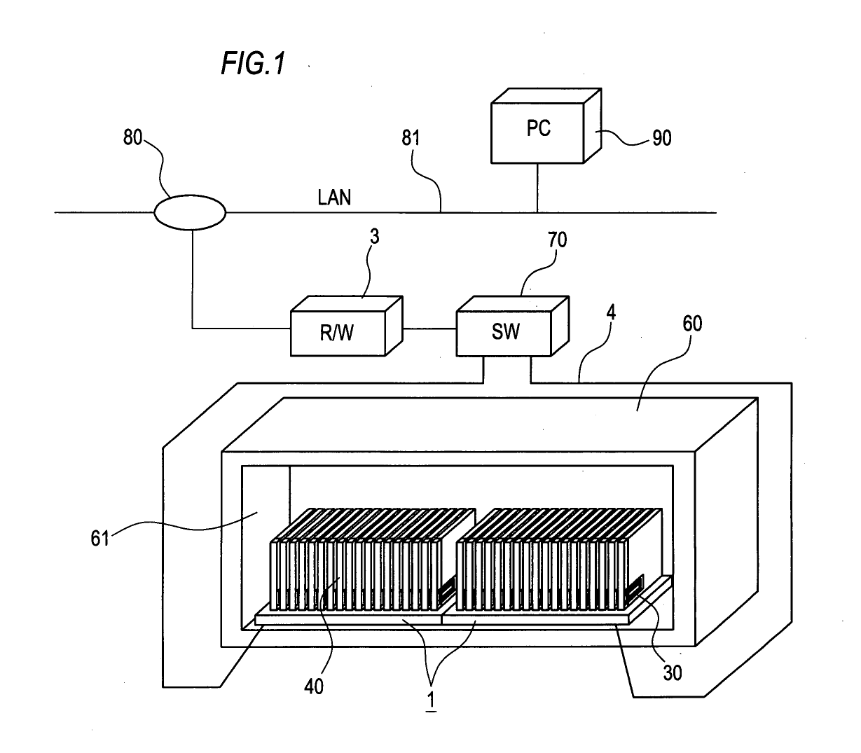

FIG. 1 is a perspective view showing an RFID system according to the first embodiment of the invention. In FIG. 1, a plurality of files 40 is accommodated as managed products in a storage space 61 of a rack 60 formed of a metal. An RFID tag 30 is stuck into a predetermined position on a cover surface of each of the files 40. The tag 30 carries out a wireless communication with a grounding type multiwinding loop antenna device 1. Moreover, FIG. 1 shows a state in which two sets of loop antenna devices 1 are accommodated.

The loop antenna device 1 is connected to an antenna change-over switch 70 through a coaxial cable 4 for connecting an antenna, and furthermore, to an RFID reader/writer 3. The reader/writer 3 serves to demodulate a signal transmitted from the antenna device 1 and to convert the demodulated signal into a signal including information which can be displayed on a PC 90.

In addition, the RFID reader/writer 3 is further connected to a network connecting apparatus 80 and is connected to the computer 90 for a control via a network LAN line 81. With the structure, it is possible to remotely manage products to be managed through a LAN network communication network in a position placed at a distance from the rack 60 for managing goods in which a plurality of products to be managed is accommodated.

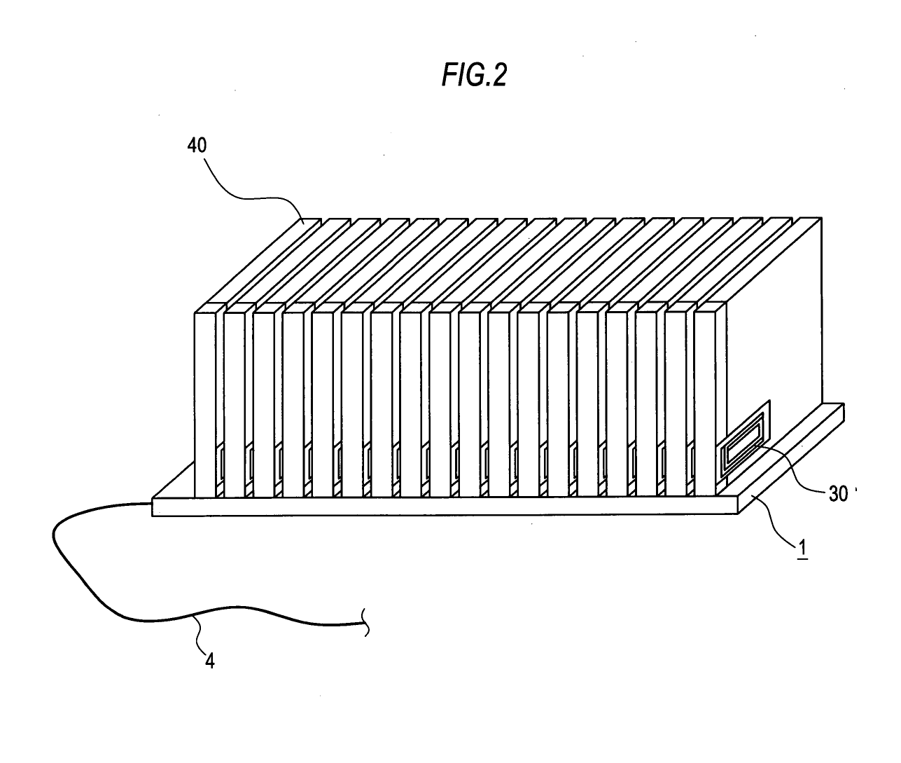

FIG. 2 shows the antenna device 1 and a plurality of files 40 having the tag 30 stuck thereto which are accommodated in the rack 60. In detail, the RFID tag 30 is stuck into predetermined positions on the cover surfaces of the files 40 which are the products to be managed and the (grounding type multiwinding) loop antenna device 1 carries out a communication with the RFID tag (the details will be described below).

In the embodiment, the flat plate-shaped grounding type multiwinding loop antenna device 1 is employed to maintain a wide tag reading range for the tags superposed on each other at a small interval. Also in case of very thin products to be used for managing books and CD/DVD, consequently, it is possible to carry out a communication with the RFID tag stuck to a surface or back face of the cover.

In the case in which the grounding type multiwinding loop antenna device 1 is installed in a wooden rack or a metallic rack to carry out a communication with the tag stuck to the goods, moreover, a regulation of an antenna impedance in the installation is not required and a convenience in the installation can be improved further considerably without the influence of a material of the rack.

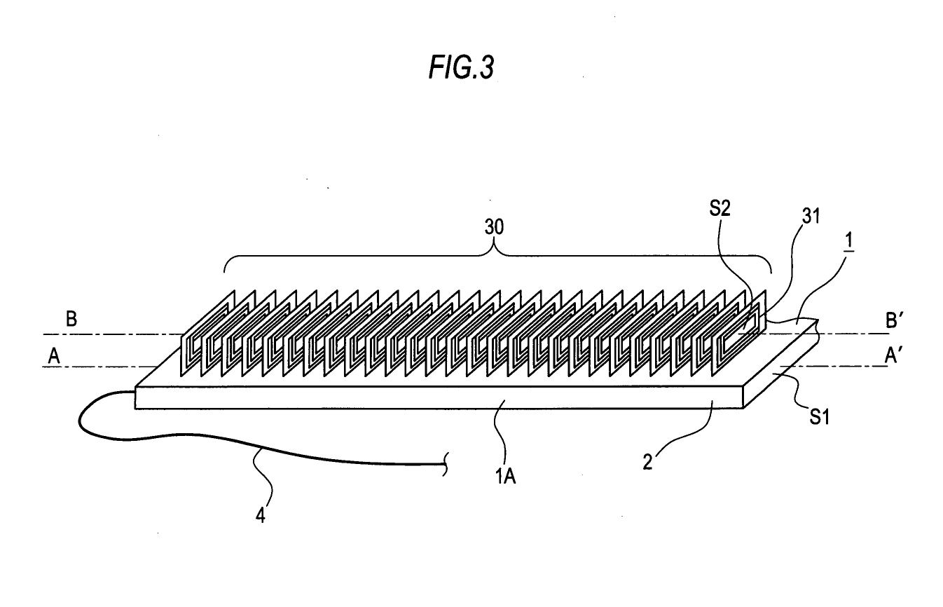

FIG. 3 is a view showing a relationship between the loop antenna device 1 and an antenna 31 of a plurality of RFID tags in an antenna for an RFID reader/writer according to the first embodiment of the invention. FIG. 3 shows the loop antenna device 1, a casing (housing) 2 for accommodating the antenna device 1, the coaxial cable 4 to be coupled to the RFID reader/writer 3 (see FIG. 1), and furthermore, the RFID tags 30 and the tag side antenna portion 31. Moreover, the tag side antenna portion 31 also has a shape of a loop. Moreover, S1 indicates an antenna opening surface of the antenna device 1. The antenna opening surface is an antenna section which is orthogonal to a longitudinal direction of an antenna provided in the antenna device 1 (which will be described below), and particularly, is present on an end of the antenna.

As shown in FIG. 3, the loop antenna device 1 is the antenna device for the RFID reader/writer according to the first embodiment, and supplies a power and transmit data through an electromagnetic induction to the RFID tags 30 including the tag side antenna portion 31 and acquires receive data from the RFID tags 30 through a fluctuation in a load of the antenna.

The ground type multiwinding loop antenna device 1 according to the embodiment will be described below in more detail.

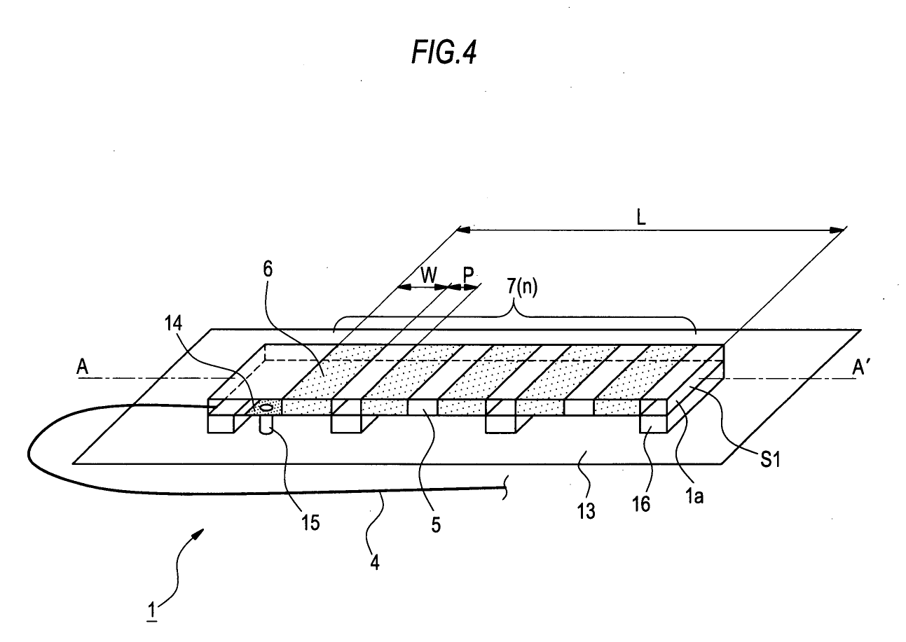

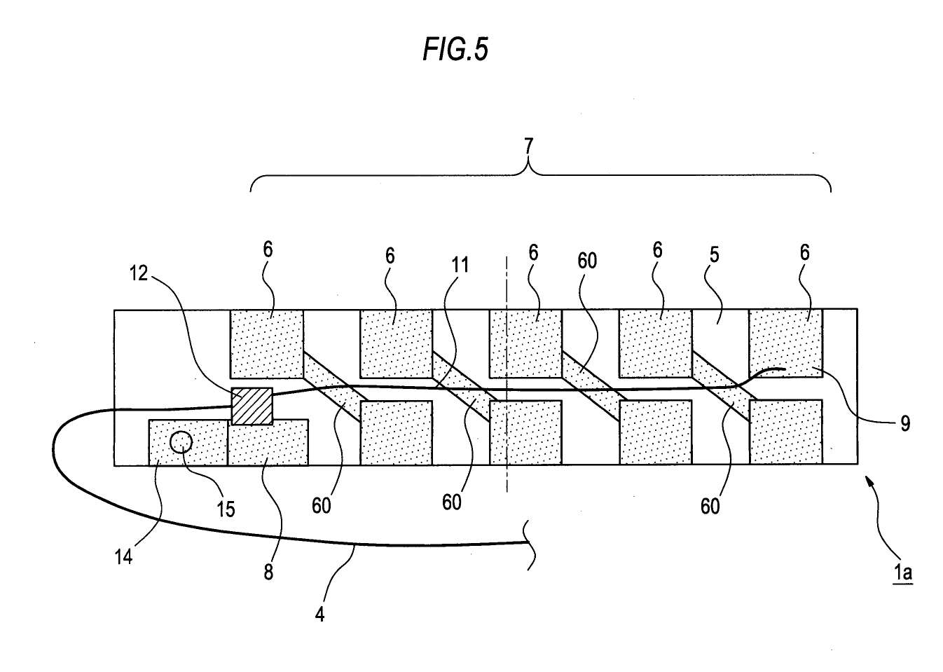

FIG. 4 is a perspective view showing the antenna device for the RFID reader/writer according to the first embodiment from which the housing 2 is removed, and FIG. 5 is a bottom view showing the antenna for the RFID reader/writer according to the first embodiment from which the housing 2 is removed, illustrating a state in which a grounding conductor board 13 and a spacer 16 are further removed.

In FIGS. 4 and 5, 1a denotes a loop antenna body, 4 denotes a coaxial cable, 5 denotes an antenna board, 6 denotes an antenna conductive wound around an outer periphery of the antenna board 5, 60 denotes a coupling (crossing) portion for coupling antenna conductors which are adjacent to each other, 7 denotes an antenna to be an assembly of the antenna conductors and the coupling portion 60, 8 denotes a starting end of the antenna conductors 6 which are connected to each other or the antenna 7, 9 denotes a terminal portion of the antenna conductors 6 which are connected to each other or the antenna 7, 10 denotes a connecting portion of the antenna conductor 6 and a transmission line 11 (which will be described below), 12 denotes a resonant matching circuit portion, and furthermore, 13 denotes a grounding conductor board, 14 denotes a grounding pattern, 15 denotes a grounding metallic pin, and 16 denotes a resin spacer.

As described above, in the first embodiment, four connecting portions 60 are provided among five antenna conductors 6, thereby constituting the antenna 7, and a power line 4a (which will be described below) of the resonant matching circuit 12 is coupled to the starting end 8 of the antenna conductor 6 through the transmission line 11 of the coaxial cable 4 and is thus conducted electrically, and a ground cable 4b (which will be described below) of the resonant matching circuit 12 is connected to the terminal portion 9 (the antenna conductor 6) and is thus coupled to the grounding pattern 14.

As shown in FIG. 4, furthermore, a loop antenna device body 1a is disposed on the grounding conductor board 13 in almost parallel through the resin spacer 16 for holding an antenna, and the ground cable 4b of the resonant matching circuit portion 12 is connected to the grounding pattern 14 in the vicinity of a power feeding portion (which will be described below) through the grounding metallic pin 15, and the metallic pin 15 is electrically connected to the grounding conductor board 13.

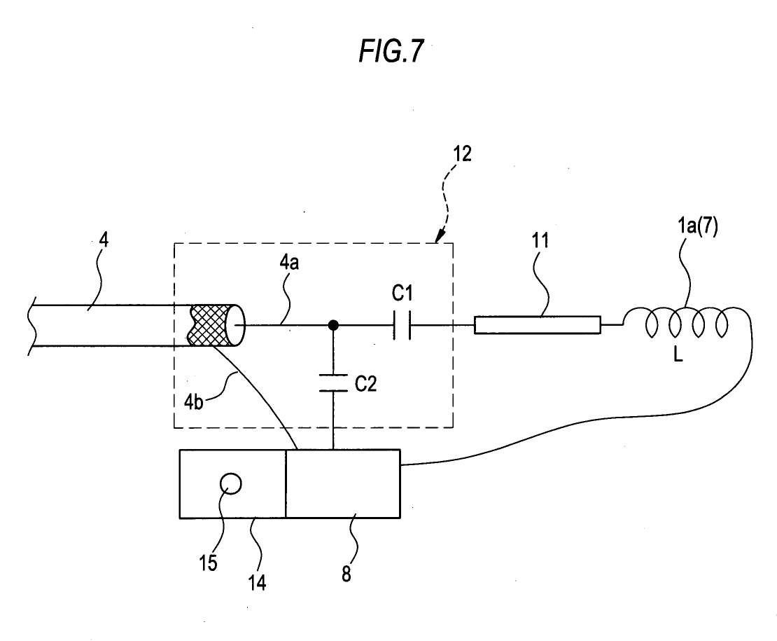

As described above, moreover, the loop antenna 7 has the starting end 8 and the terminal portion 9, and one of ends of the transmission line 11 is connected through the terminal portion 9 and the connecting portion 10, and the resonant matching circuit portion 12 having a resonant circuit portion and a matching circuit portion with the coaxial cable 4 is provided in the vicinity of the other end of the transmission line 11. The resonant matching circuit portion 12 has the function of the power feeding portion in the antenna device body 1a (see FIG. 7).

As shown in FIG. 5, the resonant matching circuit portion 12 is connected to one of ends of the coaxial cable 4 and a connector for carrying out a connection to the RFID reader/writer 3 is provided on the other end of the coaxial cable 4 (which is not shown). It is preferable that the matching circuit portion should be provided in the vicinity of the power feeding portion in the resonant matching circuit portion 12, and the resonant circuit portion may be provided in the vicinity of a center of the transmission line 11. However, it is more preferable that both of them should be disposed as the resonant matching circuit portion 12 in the vicinity of the power feeding portion.

In FIGS. 4 and 5, moreover, the loop antenna device body 1a includes the antenna board 5 and the antenna portion 7 wound around the outer periphery of the antenna board 5 (a plurality of antenna conductors 6 and a plurality of crossing portions 60).

The antenna conductor 6 has a width W. The antenna conductors 6 are provided apart from each other at a predetermined regular interval of P. Two antenna conductors 6 are connected to each other through the conductive crossing portion 60 and one antenna portion is subjected to multiwinding (n winding). FIG. 4 shows the case in which the antenna portion is wound five times.

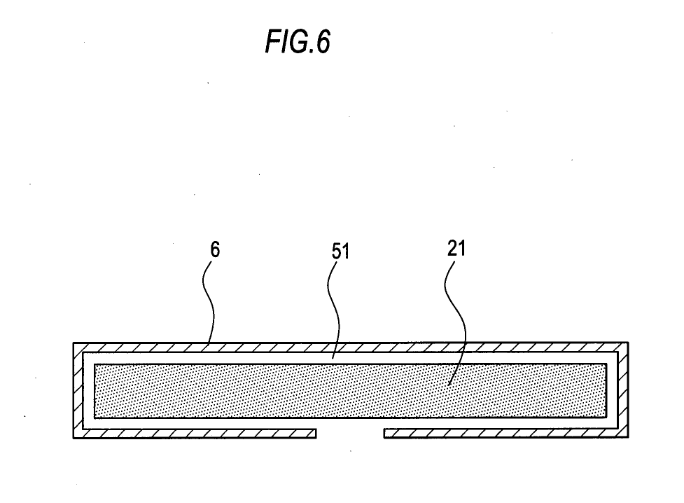

FIG. 6 is a sectional view showing the antenna for the RFID reader/writer according to the first embodiment of the invention. In FIG. 6, 6 denotes an antenna conductor, 21 denotes a magnetic material and 51 denotes an antenna board.

As shown in FIG. 6, the antenna board 51 is filled with the magnetic material 21 having a high magnetic permeability and a low loss, for example, ferrite. Consequently, a magnetic flux is concentrated to implement a further reduction in a thickness and a size, and furthermore, a magnetic field is radiated more efficiently to detect a fluctuation in a received load, thereby implementing an enhancement in a communication performance.

FIG. 7 is an explanatory view showing the resonant matching circuit of the antenna for the RFID reader/writer according to the first embodiment.

With reference to FIGS. 4, 5 and 7, the resonant matching circuit portion 12 is constituted by a resonant circuit portion including a capacitor C1 connected to the hot side (power line) 4a of the coaxial cable 4 for feeding a power and an inductance L of the antenna 7 (indicated as the coil 1a) connected to the capacitor C1 through the transmission line 11, and a matching circuit portion including the hot side 4a of the coaxial cable 4 and a capacitor C2. The ground side 4b (outer wiring) of the coaxial cable 4 for feeding a power, the ground side of the resonant matching circuit portion 12 and the starting end 8 of the antenna portion 7 of the loop antenna device body 1a are electrically grounded onto the grounding conductor board 13 through the common ground terminal (grounding metallic pin) 15 provided on the grounding pattern 14 connected to the starting end 8.

Each of the components will be described in more detail. An insulator is used for the antenna board 5, and the antenna board 5 is a printed board or a plate formed of a resin such as expandable polystyrene. Moreover, a metallic (conductive) foil or a metallic (conductive) thin plate is used for the antenna conductor 6. The same material as that of the antenna conductor 6 is used for the crossing portion 60. A covering electric wire or a strip line is used for the transmission line 11.

As shown in FIG. 4, moreover, the multiwinding loop antenna 1a is caused to have such an oblong structure as to satisfy a condition of W:P=1:N (N≦1) in a ratio of the width W and the interval P (pitch P) of the antenna conductor 6. Consequently, an increase in a reading range length and a reduction in a thickness can be implemented and a uniform magnetic field strength in a communication enable range can be implemented. Furthermore, a relationship between a winding number n of the antenna conductor 6, and an overall length L, the width W and the pitch P of the multiwinding loop antenna device 1a is caused to have such a finite value that the loop antenna device 1a does not exceed a self-resonance point of a coil.

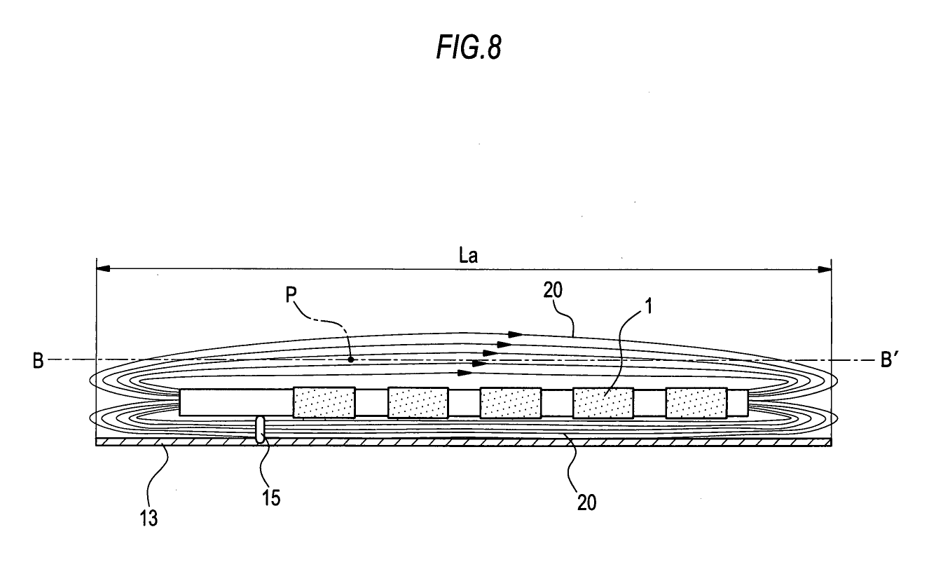

In FIG. 8, in the loop antenna device 1 having the structure, the first embodiment employs a structure in which the grounding type multiwinding loop antenna device 1 is used for the antenna for the RFID reader/writer, a central axis A-A′ of an opening surface S1 is not coincident with a central axis B-B′ of an opening surface S2 of the tag side antenna 31 of the RFID tags 30 in an antenna operation, and the RFID tags 30 are not disposed on the opening surface S1 of the grounding type multiwinding loop antenna device 1.

More specifically, a plurality of tags is arranged in such a manner that an almost center P of a magnetic flux in a magnetic field formed above the loop antenna 1 passes through the opening surface (inner peripheral portion) of the antenna of each of the tags stuck to a plurality of files mounted on the loop antenna 1. By such a structure, a magnetic field strength in a reading range can be uniform and a stabilization of a communication performance can be implemented. Consequently, a communication with the RFID tags 30 disposed at a small interval to overlap each other can be carried out well.

As shown in FIGS. 3 and 4, furthermore, the transmission line 11 such as a covering electric wire or a strip line is provided between the starting end 8 and the terminal portion 9 of the antenna conductor 6 constituting the multiwinding loop antenna device 1a, and the resonant matching circuit portion 12 having a resonant circuit portion and the matching circuit portion with the coaxial cable 4 is provided in the vicinity of one of ends thereof. Consequently, the magnetic field can be radiated efficiently at a desirable frequency and a fluctuation in a received load can be detected to implement an enhancement in a communication performance.

As shown in FIG. 4, furthermore, the grounding type multiwinding loop antenna device 1 has such a structure that the multiwinding loop antenna device 1a is disposed in almost parallel with the grounding conductor board 13 through the resin spacer 16 for holding an antenna and the grounding pattern 14 in the vicinity of the power feeding portion is electrically connected to the grounding conductor board 13 through the grounding metallic pin 15. Consequently, an impedance of the antenna is regulated in a state in which the multiwinding loop antenna device 1a is previously grounded on the grounding conductor board 13 through the grounding metallic pin 15 in a factory. In the case in which a use disposes the grounding type multiwinding loop antenna device 1 on a wooden rack or a metallic rack to carry out a communication with a tag stuck to a product after shipping, consequently, the regulation of the antenna impedance in an installation is not required and a convenience can be improved considerably in the installation without the influence of a material of the rack.

### Second Embodiment

Next, an RFID system according to a second embodiment of the invention will be described with reference to the drawings.

In a structure according to the second embodiment, an antenna device 1a for an RFID reader/writer is constituted differently from the structure according to the first embodiment. More specifically, in the second embodiment, a second antenna 17 and a resonant matching load circuit 19 are newly provided in the antenna device 1a.

The second loop antenna 17 has a non-power feed (a power is not fed from a feeding line) and the power is fed thereto from the multiwinding loop antenna device 1a in the vicinity by a non-contact method. More specifically, an induced current is generated in a non-power feeding loop antenna portion by an electromagnetic wave generated from a first multiwinding loop antenna 7 of the power feeding loop antenna device 1. The second loop antenna 17 in which the induced current is generated functions as an antenna for generating a radiated electromagnetic wave by the current which is generated and radiating an electromagnetic wave even if the power is not supplied (the details will be described below).

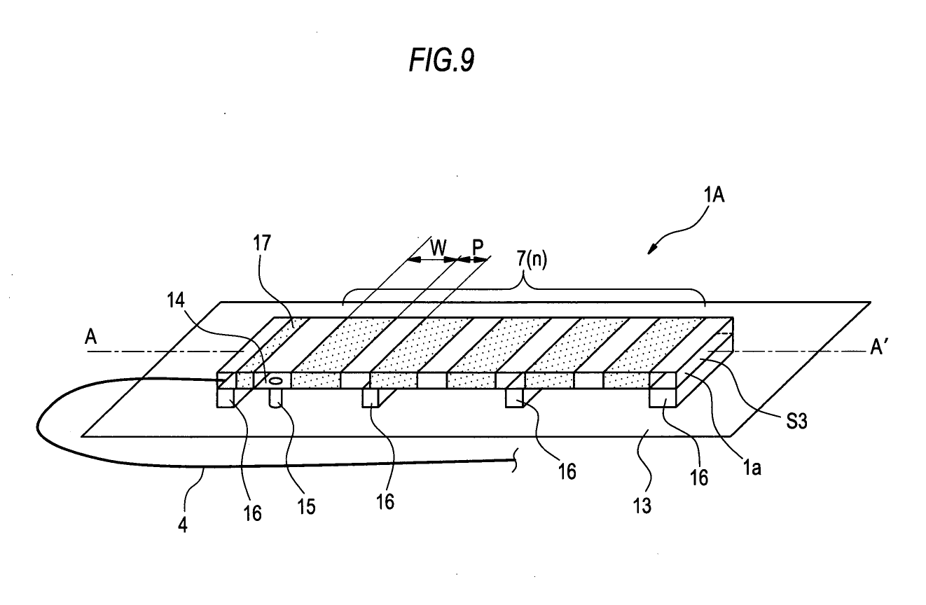

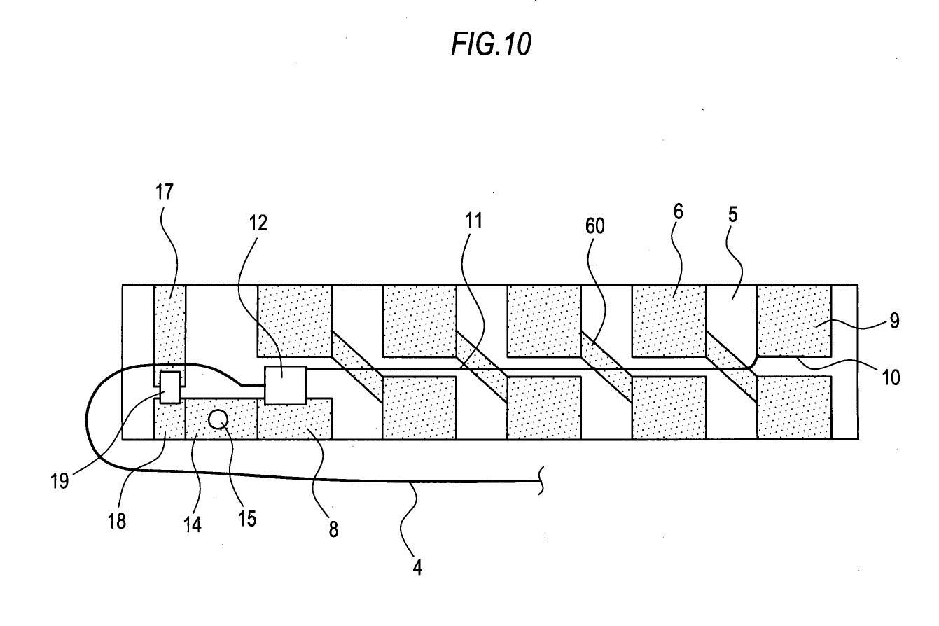

FIG. 9 is a perspective view showing an antenna device 1A of the RFID reader/writer from which a casing is removed according to the second embodiment of the invention, and FIG. 10 is a bottom view showing a state in which the casing, a grounding conductor board and a spacer in the antenna device 1A for the RFID reader/writer are removed according to the second embodiment of the invention. FIGS. 9 and 10 show the details of a state in which a housing 2 of the grounding type multiwinding loop antenna device 1 is removed.

In FIGS. 9 and 10, with a structure according to the second embodiment, the second loop antenna 17 is provided in addition to the first antenna 7 and has at least one winding. 18 denotes one of open ends of the second antenna 17 and 19 denotes a resonant matching load circuit portion. Furthermore, the open end 18 of the second loop antenna 17 is electrically connected to a grounding pattern 14 and is electrically provided on a grounding conductor board 13 through a grounding metallic pin 15.

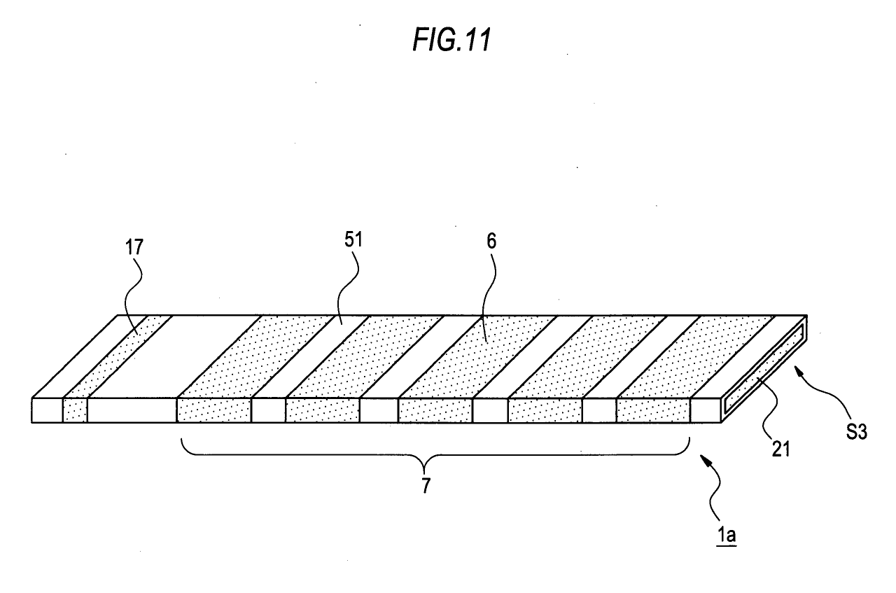

As shown in FIG. 11, an antenna board 51 is filled with a magnetic material 21 having a high magnetic permeability and a low loss, for example, ferrite in the same manner as in the first embodiment. By the filling, a magnetic flux is concentrated to implement a further reduction in a thickness and a size, and a magnetic field is radiated more efficiently and a fluctuation in a received load is detected to implement a further enhancement in a communication performance.

Referring to FIGS. 10 and 11, the resonant matching load circuit portion 19 having a resonant circuit portion and a matching load portion is provided between a winding start portion and a winding end portion of the second loop antenna portion 17.

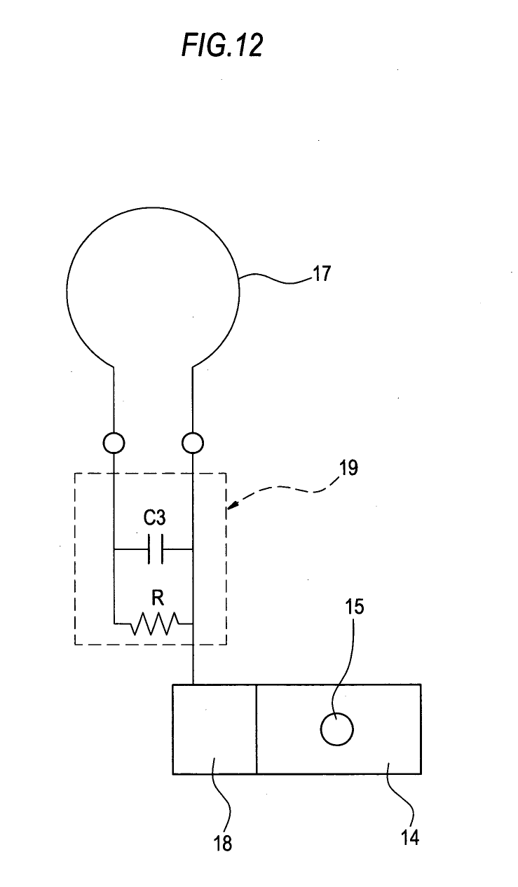

FIG. 12 is an explanatory view showing the resonant matching load circuit portion 19 of the antenna for the RFID reader/writer according to the second embodiment of the invention. As shown in FIG. 12, a capacitor C3 and a resistor R are connected to the second loop antenna 17 (indicated as one wire in FIG. 12) so that a parallel resonant circuit is constituted.

With the structure, referring to a resonance frequency of a first loop antenna 7(n) of a multiwinding loop antenna device 1a, a circuit constant of the capacitor C1 shown in FIG. 7 of the resonant matching circuit portion 12 is selected in order to constitute a resonant circuit between the capacitor C1 and an inductance value L1 of the coil 1a and to carry out a resonance to have a desirable frequency fo. Referring to a resonance frequency of the second loop antenna portion 17, moreover, a circuit constant of C3 is selected to constitute a resonant circuit between a capacitor of a resonant circuit portion of the resonant matching load circuit portion 19 (the capacitor C3 shown in FIG. 12) and an inductance value L2 of the coil 17 and to carry out a resonance to have the desirable frequency fo. By selecting a circuit constant of a resistor (R shown in FIG. 12) of the matching load portion of the resonant matching load circuit portion 19 and the resonant matching circuit portion 12 (the capacitor C2 shown in FIG. 7), furthermore, it is possible to increase a band of a frequency characteristic of an antenna impedance in a whole antenna (to be the grounding type multiwinding loop antenna device 1) seen from a tip portion 4a of a coaxial cable 4 connected to the resonant matching circuit portion 12 by a mutual interference effect of two loop antenna devices, that is, the multiwinding loop antenna portion 1a and the second loop antenna portion 17.

A structure of the multiwinding loop antenna device 1a according to the second embodiment will be described below in more detail.

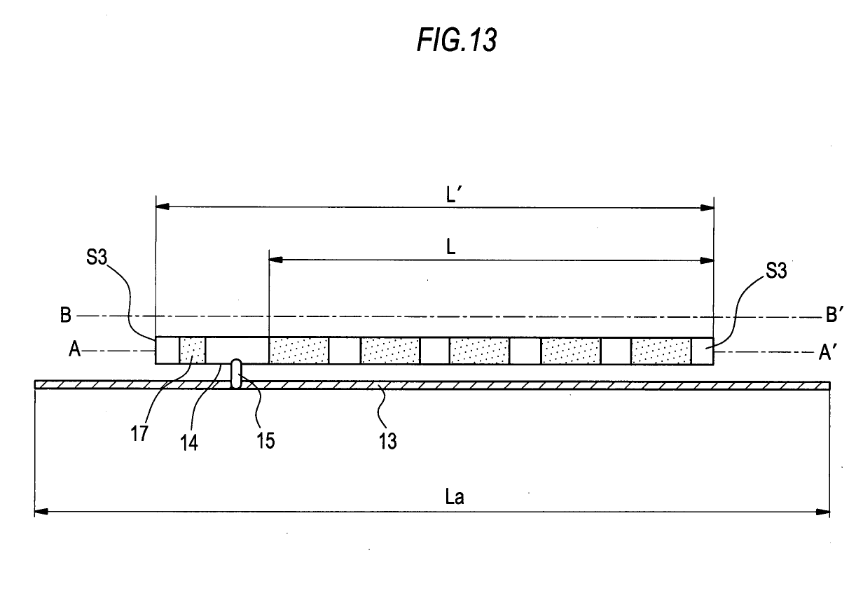

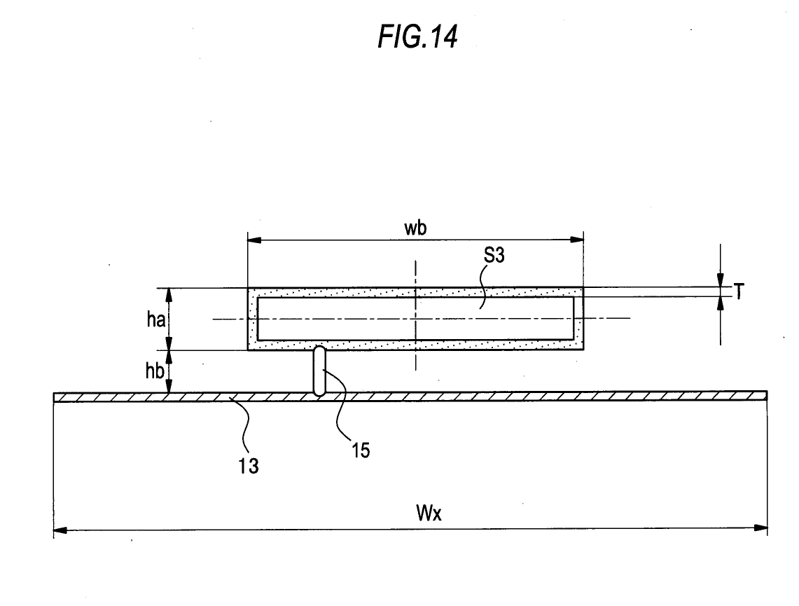

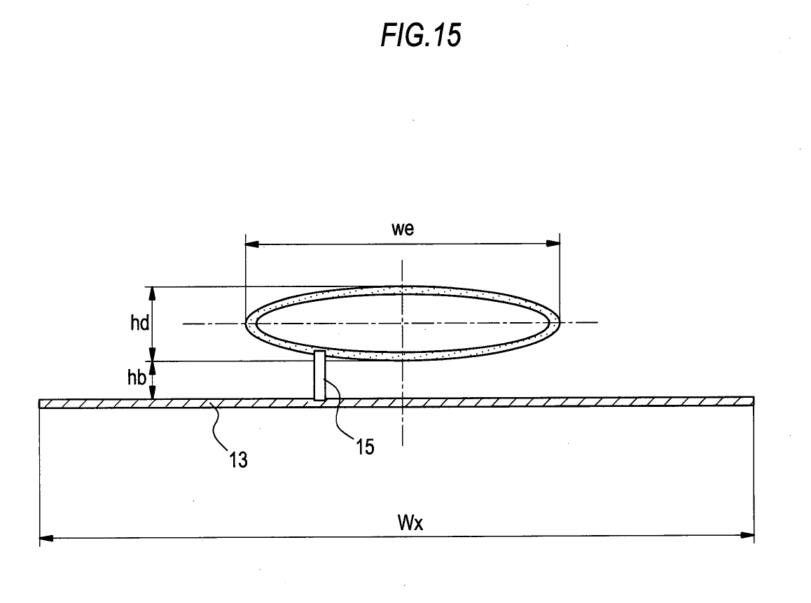

FIG. 13 is a side view showing an antenna for the RFID reader/writer according to the second embodiment of the invention, and FIG. 14 is a sectional view showing the antenna for the RFID reader/writer according to the second embodiment of the invention. Moreover, FIG. 15 is a sectional view showing another example of the antenna for the RFID reader/writer according to the second embodiment of the invention. A shape of an opening surface S3 of the multiwinding loop antenna device 1a may be almost rectangular as shown in FIG. 14 and may be almost elliptical as shown in FIG. 15.

In FIG. 13, an axis A-A′ indicates a central axis of the opening surface S3, and a central axis B-B′ of an RFID tag (not shown) to be stuck to a product mounted on an antenna device 1A is not coincident with the central axis A-A′ of an opening portion of the antenna, does not pass through the opening surface S3 of the multiwinding loop antenna device 1a and is almost parallel with the central axis A-A′.

In the same manner as in the first embodiment, in three surfaces other than the opening surface S3, an antenna conductor 6 is subjected to multiwinding in parallel with a perpendicular direction to the central axis A-A′ of the opening surface S3 of the multiwinding loop antenna device 1. Consequently, it is possible to obtain a uniform magnetic field strength within a reading range and to implement a stabilization of a communication performance (the details will be described below).

In FIGS. 13 and 14, “ha, hd” denotes a height of the opening surface S3 of the multiwinding loop antenna device 1a, “wb, we” denote a width of the opening surface S3 of the multiwinding loop antenna device 1a, “T” denotes a thickness of the antenna conductor 6, and “hb” denotes a distance between the multiwinding loop antenna device 1a and the grounding conductor board 13.

As shown in FIG. 13, there is employed a flat structure in which a ratio of the height ha to the width wb of the opening surface S3 of the multiwinding loop antenna device 1a almost satisfies a condition of ha:wb=1:N (N≧2). By the structure, it is possible to reduce a thickness of the antenna.

In the case in which the opening portion S3 takes an elliptical shape as shown in FIG. 15, furthermore, there is employed a flat structure in which a ratio of the height hd to the width we of the opening surface S3 in the multiwinding loop antenna device 1a almost satisfies a condition of hd:we=1:N (N≧2).

As shown in FIGS. 14 and 15, moreover, there is employed a flat structure in which the shape of the opening surface S3 of the multiwinding loop antenna device 1a is rectangular or elliptical and the ratio of the height h to the weight w almost satisfies a condition of h:w=1:N (N≧2).

As shown in FIGS. 13 and 14, furthermore, there is employed an oblong structure in which a ratio of the width wb of the opening surface S3 of the multiwinding loop antenna device 1a to an overall length L of the multiwinding loop antenna device 1a almost satisfies a condition of wb:L=1:N (N≧2). Consequently, it is possible to implement an increase in a reading range length and a reduction in a thickness.

As shown in FIGS. 13 and 14, moreover, there is employed an oblong structure in which a ratio of the width we of the opening surface S of the multiwinding loop antenna device 1a to the overall length L of the multiwinding loop antenna device 1a almost satisfies a condition of we:L=1:N (N≧2) Consequently, it is possible to implement an increase in a reading range length and a reduction in a thickness.

More specifically, as shown in FIGS. 13, 14 and 15, there is employed an oblong structure in which a ratio of the width w of the opening surface S of the multiwinding loop antenna device 1a to the overall length L of the multiwinding loop antenna device 1a satisfies a condition of w:L=1:N (N≧2). Consequently, it is possible to implement an increase in a reading range length and a reduction in a thickness.

The shape and ratio of the opening surface S3 described in the second embodiment is the same as that in the multiwinding loop antenna device 1a described in the first embodiment.

Referring to FIG. 13, by setting an overall length La of the grounding conductor board 13 to be greater than an overall length L′ of the multiwinding loop antenna device 1a (La:L′=N:1(N=1.1 to 1.5)), accordingly, it is possible to implement a wide tag reading range in a range of the overall length La.

By setting an overall width Wx of the grounding conductor board 13 to be greater than the overall width wb or we of the multiwinding loop antenna device 1a in relation to a transverse direction of the antenna (Wx:wb=N:1(N=1.1 to 3)) as shown in FIGS. 13 and 14, furthermore, it is possible to implement a wide tag reading range in a range of the overall width Wx, which is not shown.

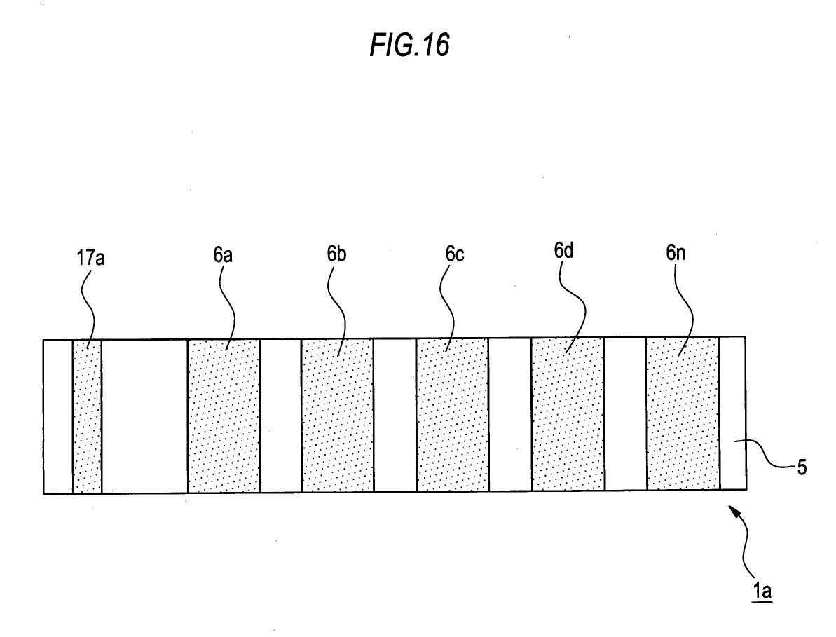

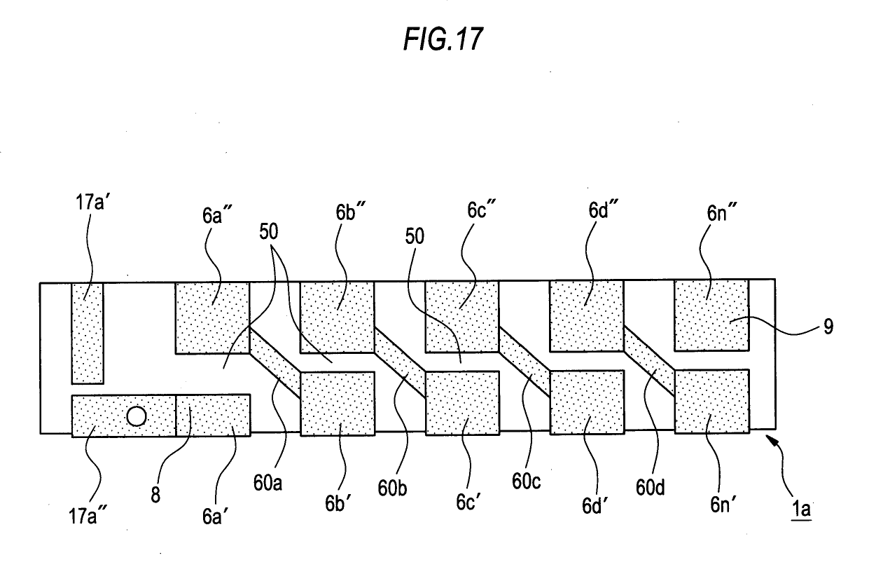

FIG. 16 is a top view showing the antenna for the RFID reader/writer according to the second embodiment of the invention, and FIG. 17 is a bottom view showing the antenna for the RFID reader/writer according to the second embodiment of the invention. FIGS. 16 and 17 show the details of a state in which the housing 2 and the grounding conductor board 13 are removed from the multiwinding loop antenna device 1a, and furthermore, FIG. 17 shows a state in which a transmission line 11 and a resonant matching circuit portion 12 in the multiwinding loop antenna device 1a are omitted.

The way of winding the antenna conductor 6 will be described below in detail.

First of all, an antenna conductor 6a is formed around an antenna board 5. As shown in FIG. 17, the formation is started from a starting end 8 of a bottom face and an antenna conductor 6a′ portion is changed into the antenna conductor 6a on a surface shown in FIG. 11, and furthermore, a return to the bottom face is carried out to form an antenna conductor 6a″ portion, and the antenna conductor 6a″ portion is linked to an antenna conductor 6b′ portion through a crossing portion 60a so that a next antenna conductor 6b is obtained. Then, winding is sequentially carried out and an antenna conductor 6″ portion is linked to an antenna conductor 6n′ through a crossing portion 60d so that a next antenna conductor 6n is obtained and n-time winding is performed. At this time, a winding end portion of an antenna conductor 6n″ portion on the bottom face acts as a terminal portion 9. In the bottom face, thus, a gap 50 is provided between the antenna conductor 6a′ (to the antenna conductor 6n′) portion and the antenna conductor 6a″ (to the antenna conductor 6n″) portion and the crossing portion 60a to 60d are provided between the antenna conductors 6a to 6n which are adjacent to each other, and the crossing portions 60a to 60d connect the antenna conductor 6a″ (to the antenna conductor 6d″) and the antenna conductor 6b′ (to the antenna conductor 6n′).

As described above with reference to the drawings, therefore, the antenna conductor 6 constituting the multiwinding loop antenna device 1 has such a structure that the antenna conductor 6a to be a first winding (loop) and the antenna conductor 6b to be a second winding are connected through the crossing portion 60a and the antenna conductor 6d to be an (n−1) winding and the antenna conductor 6n to be an n-th winding are connected through the crossing portion 60d over at least one plane.

The way of winding the antenna conductor 6 described in the second embodiment is the same for the multiwinding loop antenna device 1a described in the first embodiment.

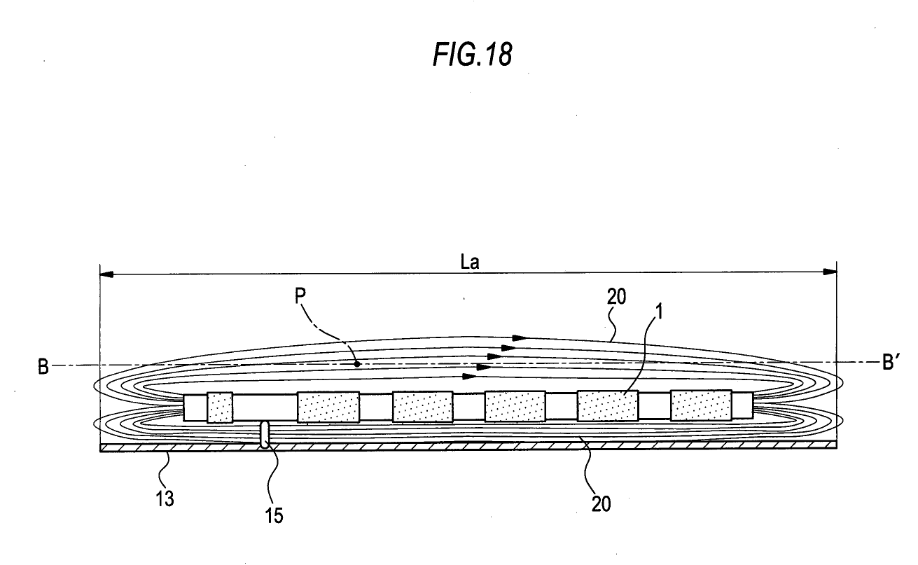

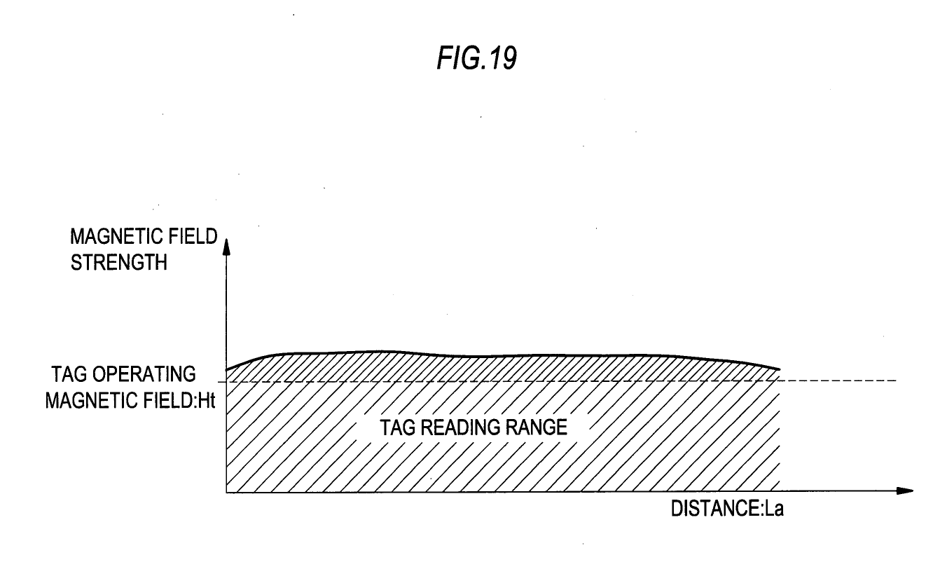

FIG. 18 is an explanatory view showing a magnetic field distribution in the operating state of the antenna for the RFID reader/writer according to the second embodiment of the invention. Furthermore, FIG. 19 is a graph showing a change in a distance and a magnetic field strength in the operating state of the antenna for the RFID reader/writer according to the second embodiment of the invention.

Moreover, FIG. 19 shows a change in a magnetic field strength at a point P on the central axis B-B′ with an increase in a length L in the case in which a length of the multiwinding loop antenna device 1a is represented as L. 20 denotes a magnetic flux and it is apparent that an almost uniform magnetic flux density is obtained within a range of the length L. In other words, the central axis B-B′ of the opening surface S of the tag side antenna 31 to be one of components of at least one RFID tag 30 is caused to be almost coincident with the central axis B-B′ and the RFID tags 30 are disposed at a small interval in a straight line over a surface at an outer peripheral side of the multiwinding loop antenna device 1. Consequently, a uniform magnetic field strength is given to these RFID tags 30, and it is possible to give a greater magnetic field strength than a tag operating magnetic field Ht determined depending on a size of the RFID tag 30 and a performance of an IC to be mounted as shown in FIG. 18.

As is apparent from FIG. 18, moreover, a direction of the magnetic flux 20 is parallel with the grounding conductor board 13. Therefore, it is possible to suppress the generation of an eddy current, to reduce a loss caused by the eddy current very greatly, and to implement an enhancement in a radiation efficiency.

Many modifications and variations of the present invention are possible in the light of the above techniques. It is therefore to be understood that within the scope of the invention the invention may be practiced otherwise than as specifically described.

This application is based upon and claims the benefit of priority of Japanese Patent Application No 2005-359954 filed on May 12, 1914, the contents of which are incorporated herein by reference in its entirety.

What is claimed is:

1. A reader comprising an antenna device for supplying a power and transmit data through an electromagnetic induction to a plurality of tags having an IC chip for storing predetermined information and a loop antenna and acquiring the information from the tags depending on a fluctuation in a load,
wherein the antenna device includes:
a conductor board;
an antenna body wounded spirally around an outer peripheral surface of the conductor board;
a power feeding portion coupled to the antenna body and serving to feed a power; and
a ground connecting portion coupled to the antenna body and connected to a ground.

2. The reader according to claim 1, wherein the antenna body has one metallic conductor and the metallic conductor is wound around the conductor board almost wholly.

3. The reader according to claim 1, wherein the antenna body has a plurality of conductor portions which is almost orthogonal to a longitudinal direction of the conductor board and a conductor coupling portion for coupling the conductor portions which are orthogonal to each other.

4. The reader according to claim 3, wherein the orthogonal conductor portions of the antenna body are wound apart from each other by an almost equal distance in the longitudinal direction of the conductor board.

5. The reader according to claim 1, wherein the conductor board is filled with a magnetic material.

6. A reader comprising an antenna device for supplying a power and transmit data through an electromagnetic induction to a plurality of tags having an IC chip for storing predetermined information and a loop antenna and acquiring the information from the tags depending on a fluctuation in a load,
wherein the antenna device includes:
a conductor board;
an antenna body wounded spirally around an outer peripheral surface of the conductor board;
a power feeding portion coupled to the antenna body and serving to feed a power; and
a ground connecting portion coupled to the antenna body and connected to a ground, and
the antenna body has a first antenna member wound around the conductor board apart from each other by a predetermined distance and a second antenna member wound apart from the first antenna member by a longer distance than the predetermined distance, and the second antenna member is provided electrically apart from the power feeding portion and is coupled to the ground connecting portion.

7. The reader according to claim 6, wherein the antenna body has one metallic conductor and the metallic conductor is wound around the conductor board almost wholly.

8. The reader according to claim 6, wherein the antenna body has a plurality of conductor portions which is almost orthogonal to a longitudinal direction of the conductor board and a conductor coupling portion for coupling the conductor portions which are orthogonal to each other.

9. The reader according to claim 8, wherein the orthogonal conductor portions of the antenna body are wound apart from each other by an almost equal distance in the longitudinal direction of the conductor board.

10. The reader according to claim 6, further comprising a transmission line for coupling both ends of the antenna body and a resonant matching circuit portion having a resonant circuit and a matching circuit which are provided in the vicinity of one of ends of the transmission line.

11. The reader according to claim 6, wherein the conductor board is filled with a magnetic material.

12. The reader according to claim 6, wherein the second antenna member includes a resonant matching load circuit portion having a resonant circuit and a matching load portion.

13. The reader according to claim 6, wherein there is employed a flat structure in which a cross-sectional shape of the conductor board is rectangular or elliptical and a ratio of a height h to a width w almost satisfies a condition of h:w=1:N (N≧2).

14. The reader according to claim 6, wherein there is employed an oblong structure in which a ratio of a maximum length w to an overall length L of a cross section of the conductor board almost satisfies a condition of w:L=1:N (N≧2).

15. The reader according to claim 6, wherein an antenna conductor provided in the antenna body is constituted by a conductive foil or a conductive thin plate and has an oblong structure in which a ratio of a width W to a pitch P of the antenna body almost satisfies a condition of W:P=1:N (N≧1).

16. The reader according to claim 6, wherein a relationship between a winding number n of an antenna conductor provided in the antenna body, and an overall length L, a width W and a pitch P of a multiwinding loop antenna device has such a finite value that the antenna body does not exceed a self-resonant point of a coil.
